(19) United States
(12) Patent Application Publication
(10) Pub. No.: US 2025/0326051 A1
(43) Pub. Date: Oct. 23, 2025

(54) ENAMEL ENGRAVING AND TEXTURING METHOD

(71) Applicant: Comadur SA, Le Locle (CH)

(72) Inventors: Johan ROMAND, Mamirolle (FR); Bastien COMBOTTE, Villers-Le-Lac (FR); Pierry VUILLE, Les Emibois (CH); Geoffrey RICHERT, Morteau (FR)

(73) Assignee: Comadur SA, Le Locle (CH)

(21) Appl. No.: 19/068,584

(22) Filed: Mar. 3, 2025

(30) Foreign Application Priority Data
Apr. 23, 2024 (EP) 24171993.9

(51) Int. Cl. B23K 26/0622; B23K 26/352; B23K 26/364; B23K 103/00; G04B 37/22

(52) U.S. Cl. CPC B23K 26/0624; B23K 26/355; B23K 26/364; G04B 37/225; B23K 2103/52

(57) ABSTRACT

A method for engraving and texturing an item (1) including a decoration (2) filled at least partially with an enamel (3), the method including a laser ablation step using a femtosecond or picosecond laser on the surface of the enamel (3) and/or within the enamel (3) to produce a structure (7).

### Cross Reference to Related Applications

This application is claiming priority based on European Patent Application No. 24171993.9 filed on Apr. 23, 2024.

### TECHNICAL FIELD OF THE INVENTION

The invention relates to a method for engraving and texturing an item with an enamel decoration, for example a plique-à-jour enamel decoration. The invention further relates to the method for manufacturing the item and to the item resulting from this method.

### TECHNOLOGICAL BACKGROUND

A number of age-old techniques can be used to create decorations on translucent stone or glass paste. Many intaglios were made in ancient times, either in semi-precious stones or in glass paste. The decoration is thus obtained by manual cutting and polishing, and in some cases by moulding for glass paste. Most of the objects found are decorated on the top, and in rare cases, on the underside, giving a hologram effect.

Intra-material engraving has been used for some years in the watch industry. It can be used, for example, to make anti-counterfeiting markings or to integrate a decorative filigree into a sapphire crystal. It can also be used to customise decorative objects made of crystal or polycarbonate.

To date, enamel engraving is not widely used because it requires a mastery of the engraving technique to avoid damaging the surface of the enamel and altering its colour.

### SUMMARY OF THE INVENTION

The aim of this invention is to develop an engraving and texturing method for enamel that overcomes the above-mentioned drawbacks.

The method can be used for any enamel decoration and in particular for a plique-à-jour enamel decoration, i.e. for an enamel through-decoration, where the effect is that of a miniature stained glass window with the light shining through the transparent or translucent enamel. More specifically, it can be applied to a plique-à-jour enamel decoration with a thickness greater than or equal to 0.5 mm, so as to reduce the brittleness of the enamel, which is all of the more important for enamel decorations that are subject to heavy stress, for example external timepiece components such as watch bezels.

More specifically, the invention relates to a method for engraving and texturing an item comprising a decoration filled at least partially with an enamel, said method comprising a laser ablation step using a femtosecond or picosecond laser on the surface of the enamel and/or within the enamel to produce a structure.

The engraving and texturing method according to the invention allows laser ablation to be carried out while controlling the surface finish and limiting alteration of the colour of the enamel.

Upstream of this engraving and texturing method, the item with a plique-à-jour enamel decoration can be produced using a manufacturing method that allows thick layers of enamel to be deposited in a short space of time, leading to low-cost mass production with increased enamel robustness.

To this end, a method is proposed for manufacturing an item comprising a through-decoration filled at least partially with enamel to form the so-called plique-à-jour enamel, the manufacturing method comprising steps of engraving and texturing and comprising, before or during said engraving and texturing steps, the steps of:
Obtaining a blank defined with an upper face and a lower face opposite the upper face;
Removing part of the blank from the upper face to produce a decoration that does not pass through to the lower face or, alternatively, in the previous step, obtaining said blank directly with the non-through decoration;
Depositing one or more layers of enamel within the non-through decoration and firing the enamel after each layer has been deposited;
Machining, preferably by grinding, the lower face to reveal the enamel and thus produce the item with the through-decoration filled with enamel.

This method is highly reproducible, allowing large production volumes to be achieved at very low cost. Complex shapes are only limited by the resistance of the substrate materials during firing or impacts.

This method allows thick layers of enamel to be deposited, making it possible to obtain an enamel with a total thickness greater than or equal to 0.5 mm with a limited number of layers, typically less than 10. This greater thickness of the enamel compared with that of enamels in the prior art means that it is less brittle and can thus be used to make external components, such as bezels, which are subject to significant stress.

The transparent enamel decoration with engraving will create a depth that is impossible to achieve today.

### BRIEF DESCRIPTION OF THE FIGURES

FIG. 1A to 1F represent the 6 steps of a first alternative embodiment of the method for manufacturing an item, namely a bezel, with an enamel decoration according to the invention. In each figure, a diagrammatic cross-sectional view of part of the item or blank and a three-dimensional view of part of the item or blank are shown. The three-dimensional views in FIG. 1A and 1F are views from above the blank or item respectively, whereas views 1B to 1E are views from below the blank.

FIG. 2 is a three-dimensional view of the bezel produced by the manufacturing method according to the first alternative embodiment.

FIG. 3A to 3E represent the 5 steps of a second alternative embodiment of the method for manufacturing an item, namely an oscillating weight, with an enamel decoration according to the invention. In each figure, a diagrammatic cross-sectional view of part of the item or blank and a three-dimensional view of part of the item or blank are shown.

FIG. 4A to 4C show diagrammatic cross-sectional views of the item, representing the method of engraving and texturing an item with an enamel decoration, obtained for example with the first alternative embodiment of the manufacturing method according to the invention.

FIG. 5A to 5C are diagrammatic views of the step of engraving and texturing the enamel decoration by laser ablation. In FIG. 5A, engraving is carried out on the surface of the enamel, whereas in FIG. 5B, it is carried out within the enamel. In FIG. 5C, it is carried out on the face opposite the laser beam point-of-entry.

### DETAILED DESCRIPTION OF THE INVENTION

The invention relates to a method for engraving and texturing an enamel decoration on an item. The item can, for example, be a timepiece component. More specifically, it can be an external component chosen from the non-exhaustive list that includes a middle, a back, a bezel, a crown, a push-piece, a bracelet link, a bracelet, a tongue buckle, a clasp, a dial and a hand. The method is particularly well suited to the manufacture of items subject to high stresses, such as an external component. It may also consist of a component of the movement such as an oscillating weight. Hereafter, the invention will be more specifically described for a bezel and for an oscillating weight.

The engraving and texturing method can be used for any enamel decoration. The decoration may or may not be a through-decoration. The decoration can be entirely filled with enamel or filled with enamel and another material such as, for example, a luminescent material. In the case of a through-decoration filled at least partially with enamel, this is referred to as a plique-à-jour enamel decoration.

The engraving and texturing method according to the invention is carried out by laser ablation within the enamel or on the surface of the enamel. It should be noted that the term “engraving” will be used somewhat imprecisely to refer to the creation of a recess typically with a depth of a few tenths of a millimetre and the term “texturing” for more shallow engraving to a depth of a few hundredths of a millimetre. For the sake of simplicity, the term “engraving” will be used in general hereafter to refer to either engraving or texturing.

A very short-pulse laser is used to perform these engravings. The order of magnitude can range from picoseconds to femtoseconds. Typically, the range of values lies between 250 and 500 femtoseconds.

Near infrared wavelengths, i.e. wavelengths between 700 and 2500 nm, and green wavelengths, i.e. wavelengths between 510 and 560 nm can be used. A UV laser with a wavelength of between 200 and 400 nm can also be used, with this technology being particularly suitable for fine engraving operations.

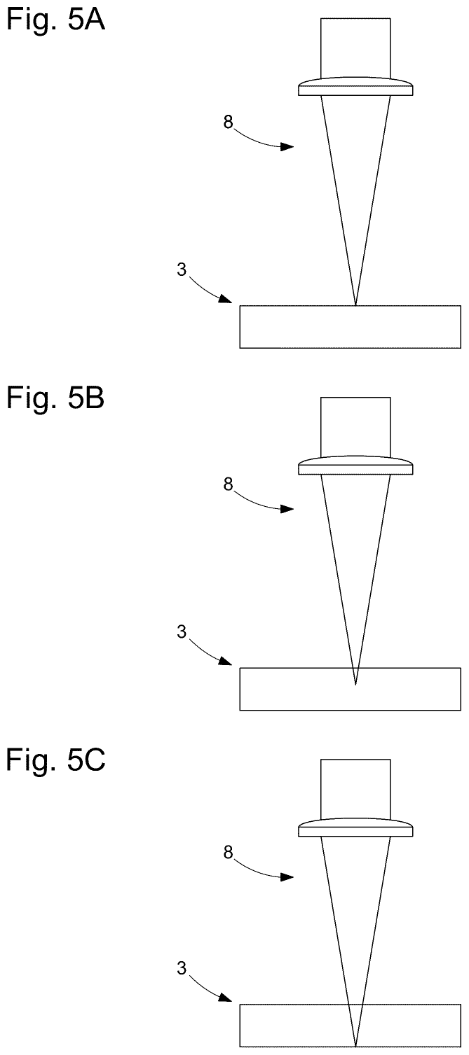

Intra-enamel engraving is achieved by focusing the beam 8 in the enamel 3 as diagrammatically shown in FIG. 5B and by generating a matrix of impacts, whereas surface engraving requires focusing close to the surface to ablate the material as diagrammatically shown in FIG. 5A. Typically, for intra-enamel engraving, the wavelength is 1030 nm, i.e. in the near infra-red range, and for surface engraving, the wavelength is 515 nm, i.e. in the green range. For UV lasers, the wavelength is typically 355 nm.

Typically, the beam energy is between 10 μJ and 30 μJ and the frequency between 200 KHz and 1000 KHz.

For surface engraving of the enamel, the upper face of the part can be engraved directly from above; however, the lower face can also be engraved via a “bottom-up” technique. This strategy involves passing through the transparent material without generating any interaction and focusing the beam 8 on the lower face to remove material, as diagrammatically shown in FIG. 5C. In the case of a translucent/transparent enamel, engraving on the lower face will create a depth effect, or even a hologram, from the upper face. It is possible to add a material, and in particular a luminescent material, to accentuate the effect of depth in the case of engraving from below. In the case of laser ablation on the upper face, a decoration made of another material, for example lacquer, inlaid metal or even another enamel, can then be deposited. For example, a transparent enamel matrix can be produced, into which an opaque enamel is then deposited.

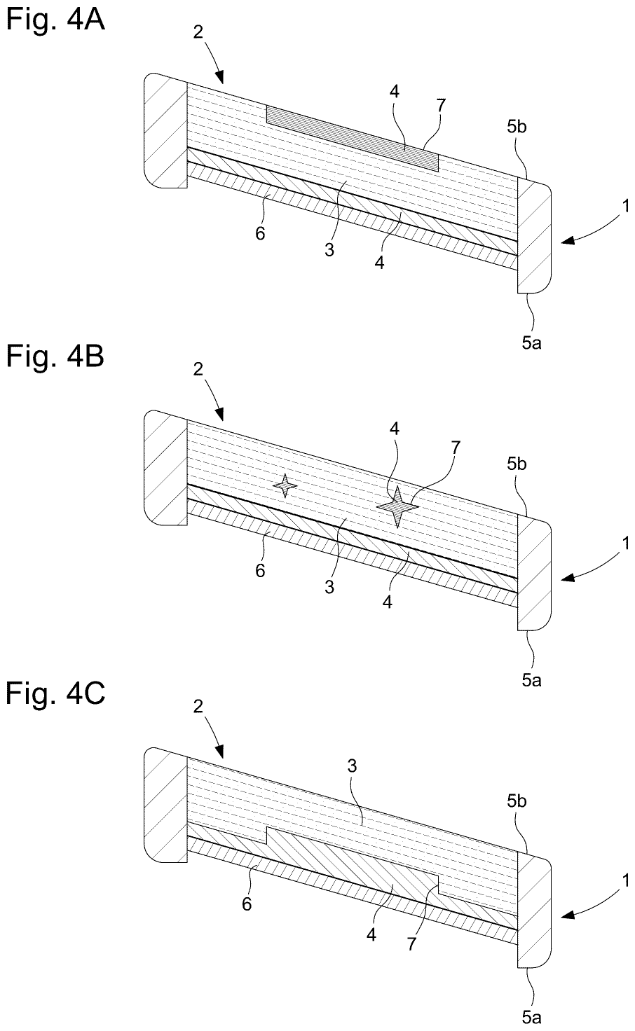

The different locations within or on the surface of the enamel 3 are illustrated in FIG. 4A to 4C. In FIG. 4A and 4C, the engraving 7, also referred to hereafter as the structure, is made on one of the faces of the enamel 3 within the decoration 2, which is a through-decoration in the example shown. When the engraving is made on the surface, the structure can be filled with a material 4 which can, for example, be a luminescent material. It could also be another enamel, for example an enamel with a different colour or opacity. In FIG. 4B, the engraving 7 is made within the enamel 3. The structure 7 can be filled with material 4 if the engraving is carried out between the deposition of the various layers of enamel 3 during the method for manufacturing the enamel decoration. If the engraving 7 is carried out after the enamel layers have been deposited, the engraving will simply form a structure within the enamel.

Prior to or during engraving and texturing, the item with the enamel decoration can be manufactured using different methods. The manufacturing method will be described below for two preferred alternative embodiments which allow a plique-à-jour enamel decoration to be produced with an enamel thickness of 0.5 mm or more in a short cycle time. It is understood that other manufacturing methods are also possible.

The manufacturing methods described below are suitable for any substrate with a melting point higher than that of the enamel firing temperature, which is typically between 650° C. and 1100° C. depending on the composition of the enamel. The method is particularly well suited to a substrate made of a hard material such as ceramic, for example silicon nitride, zirconium oxide or aluminium oxide, or such as a sapphire or like a cermet. Some ceramics, particularly ZrO₂, have excellent mechanical-chemical adhesion with enamel, and their coefficients of expansion are very close, which causes the openwork item to retain excellent mechanical strength. These materials withstand firing cycles of up to 1000° C. for high-fire enamels, for example, and resist thermal shock for rapid firing cycles.

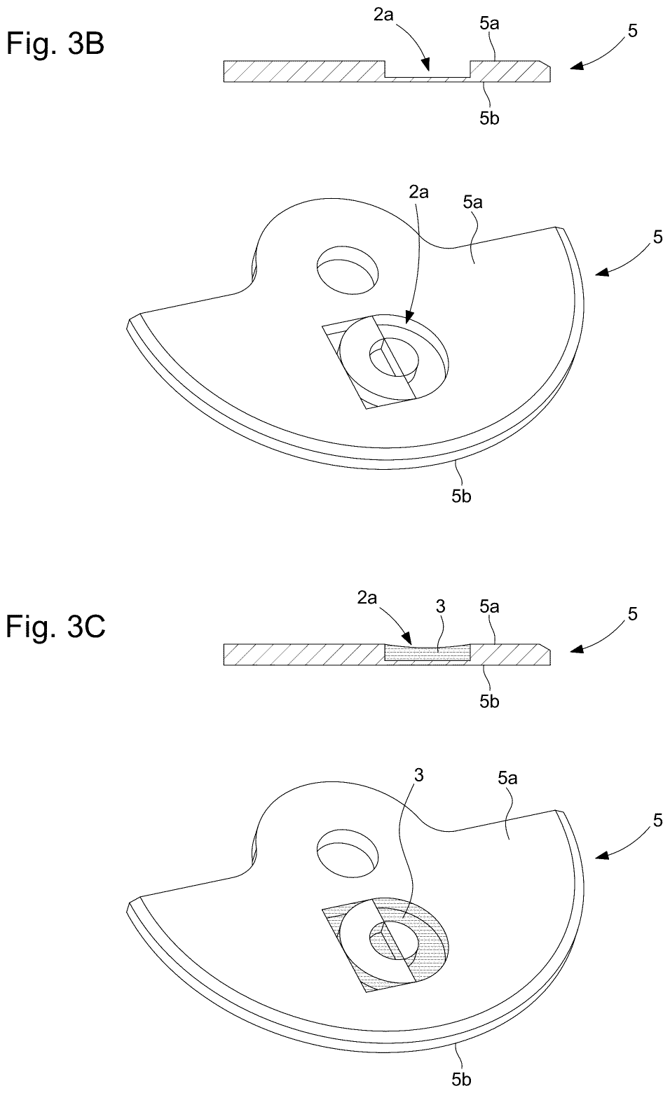

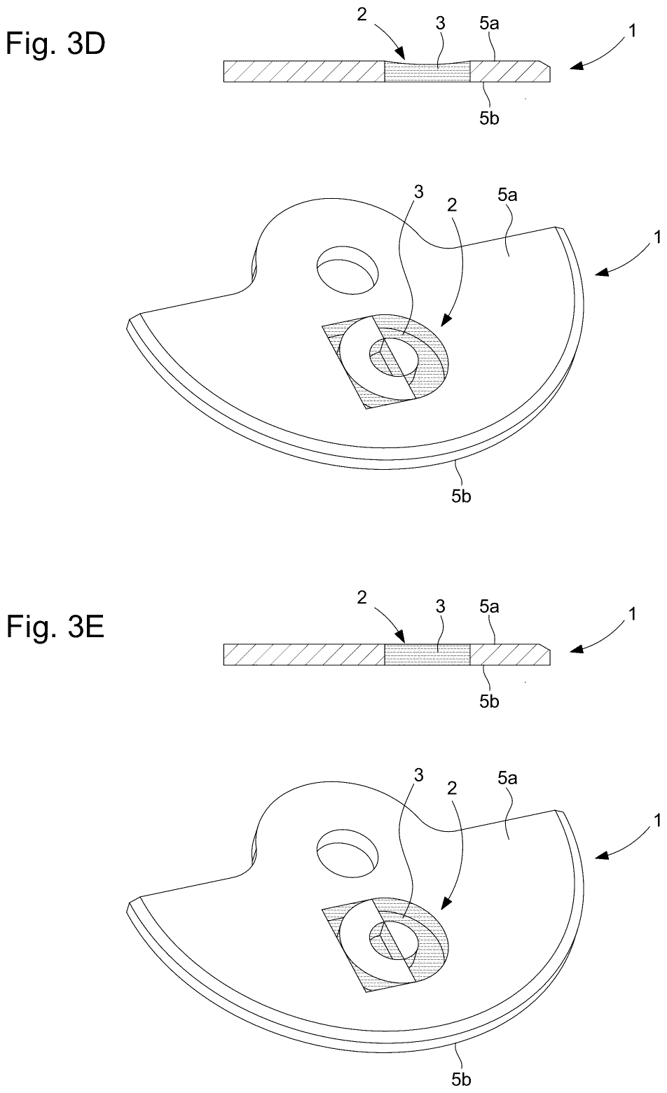

The manufacturing method according to one alternative embodiment is illustrated in FIG. 3A to 3E in 5 steps from a) to e) for an oscillating weight. In a first step a), the item without any decoration, which will be referred to as a blank 5 or substrate, is obtained. The blank is defined with an upper face 5a and a lower face 5b opposite the upper face 5a. The upper face 5a can be either the face intended to face the observer when in use or the opposite face. In a second step b), a non-through decoration 2a is produced from the upper face 5a. The non-through decoration can, for example, be produced by laser ablation. Optionally, this step b) can be omitted if a blank provided with the non-through decoration 2a is directly obtained in step a), this blank being produced by injection moulding for example. In a third step c), the enamel 3 is deposited within the non-through decoration 2a. Ideally, the deposit is carried out by liquid spraying with a view to industrial production. Alternatively, it can be deposited quickly by hand using a brush or by sprinkling a powder. The blank 5 is then fired to vitrify the deposited enamel. Preferably, a plurality of layers of enamel are deposited with, after each deposition step, a firing cycle to ensure that the enamel is bubble-free. Enamel layers of different colours can be deposited and/or the colour of the enamel deposited for each layer can be varied. The number of layers of enamel deposited is typically between 2 and 15, preferably between 3 and 10, for a total thickness greater than or equal to 0.5 mm, preferably greater than or equal to 0.8 mm. The maximum total thickness can be as much as 1.5 mm, with the maximum thickness being limited only by production times. A fourth machining step d) is then carried out, preferably by grinding, on the lower face 5b of the blank 5 to reveal the enamel 3, thus obtaining the through-decoration 2. Then, preferably, a final polishing operation is carried out to make the ground surface perfectly shiny and guarantee good transparency of the enamel. Optionally, in step e), the upper face 5a can also be machined by grinding to obtain an enamel decoration perfectly flush with the substrate. Again, this machining can be completed by polishing. In the case of a flat part, grinding and polishing of the top and bottom can be carried out in a single operation using satellite lapidary machines. According to the invention, the upper and/or lower face can be machined in an inclined plane to obtain a translucent-opaque graduation if the enamel layer has an opaque appearance before machining. It should be noted that the opaque, transparent or translucent appearance will be dictated by the greater or lesser presence of pigments within the enamel and by the thickness of the layer.

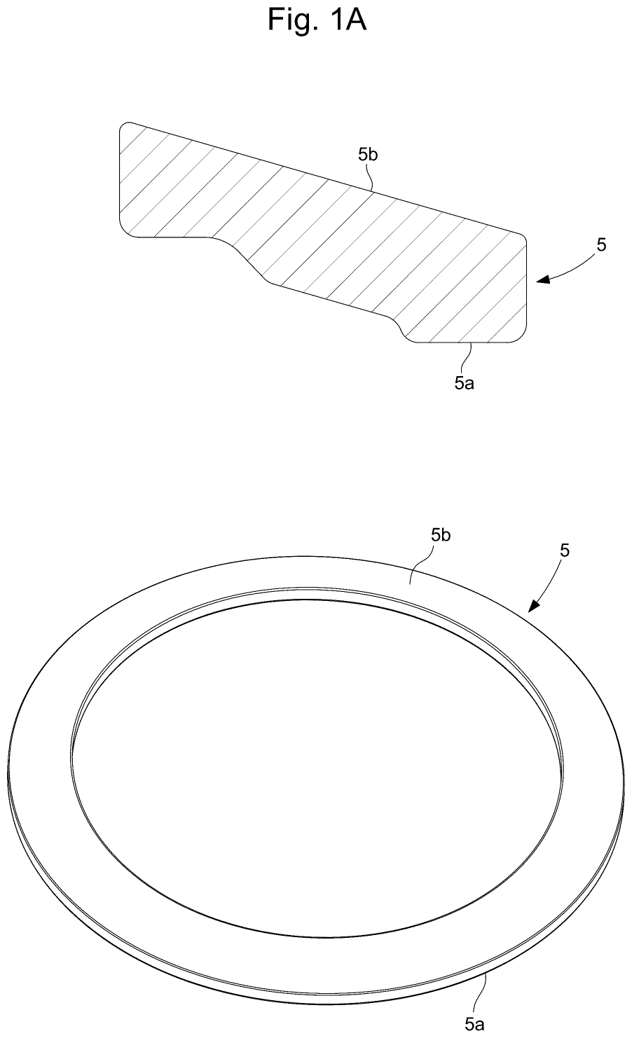

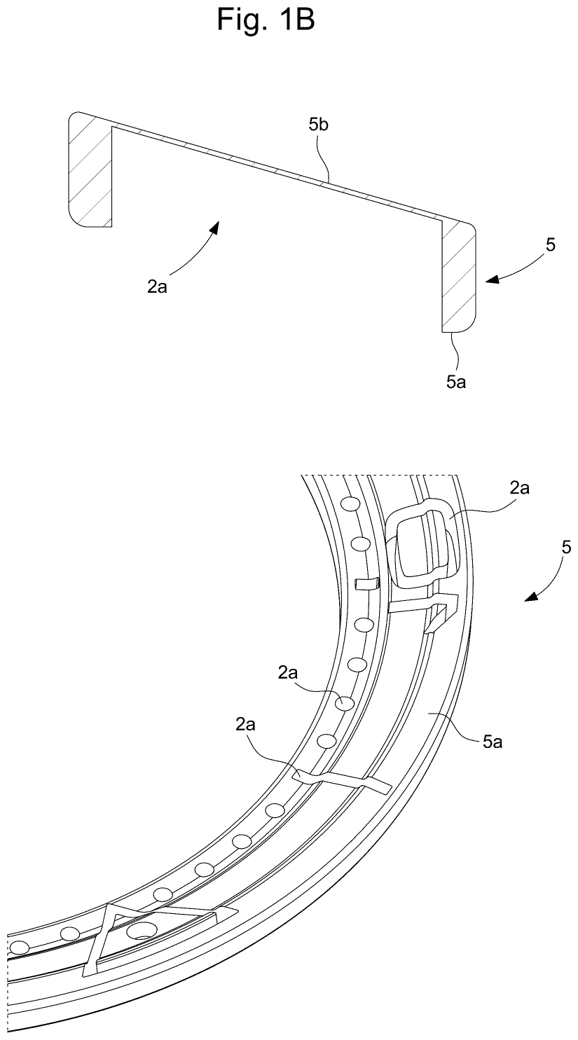

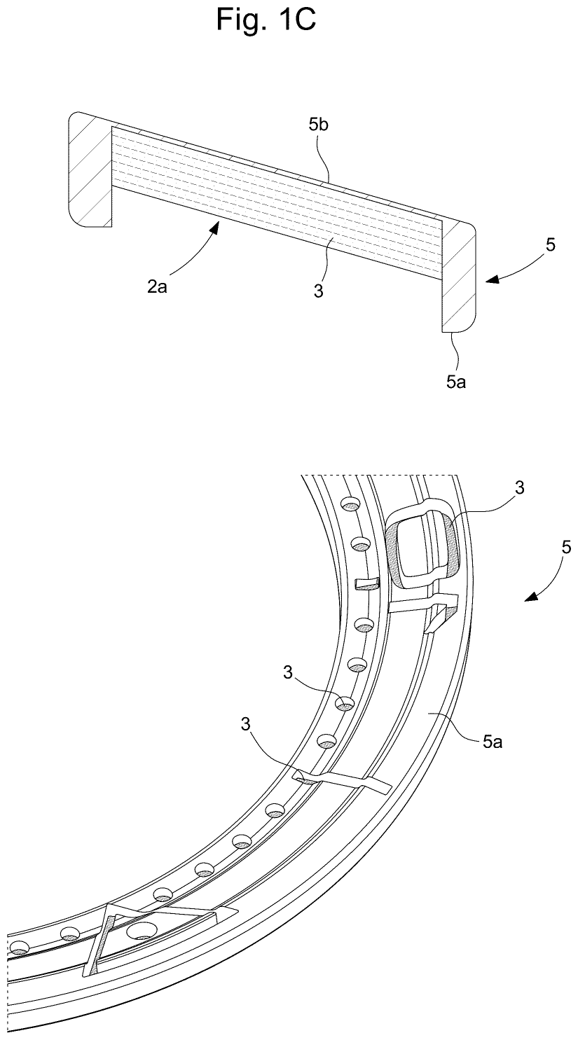

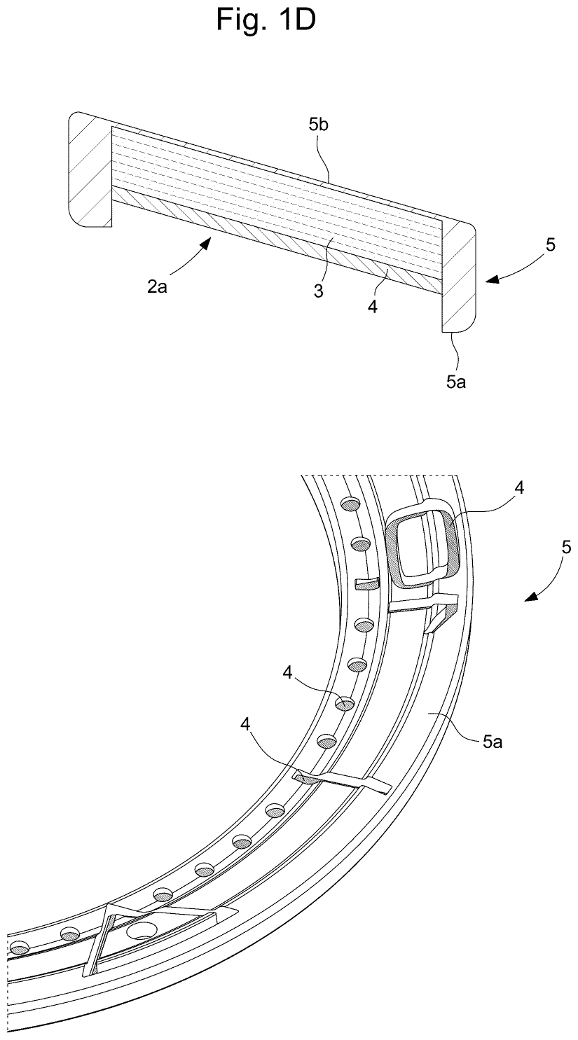

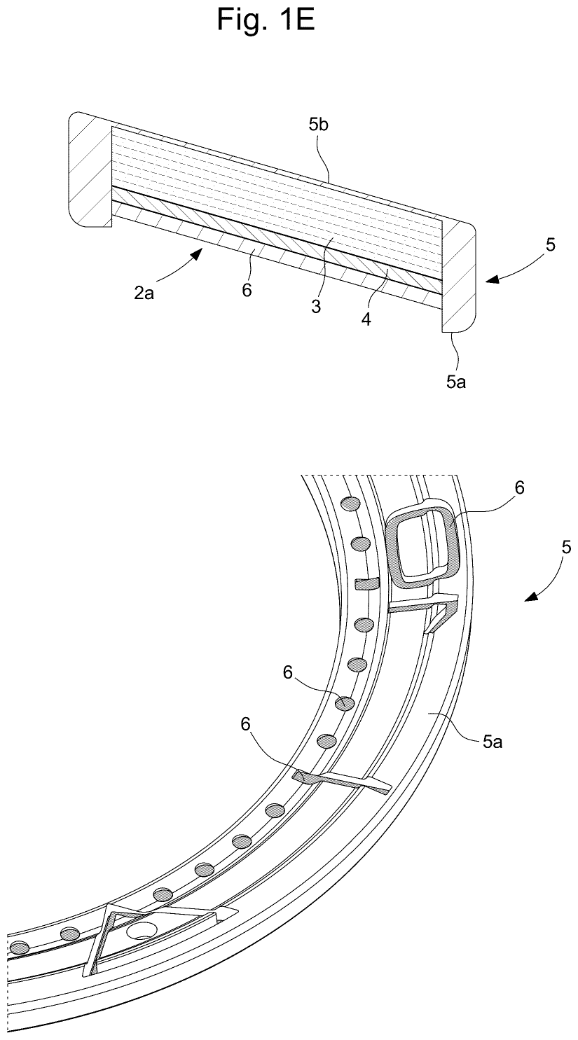

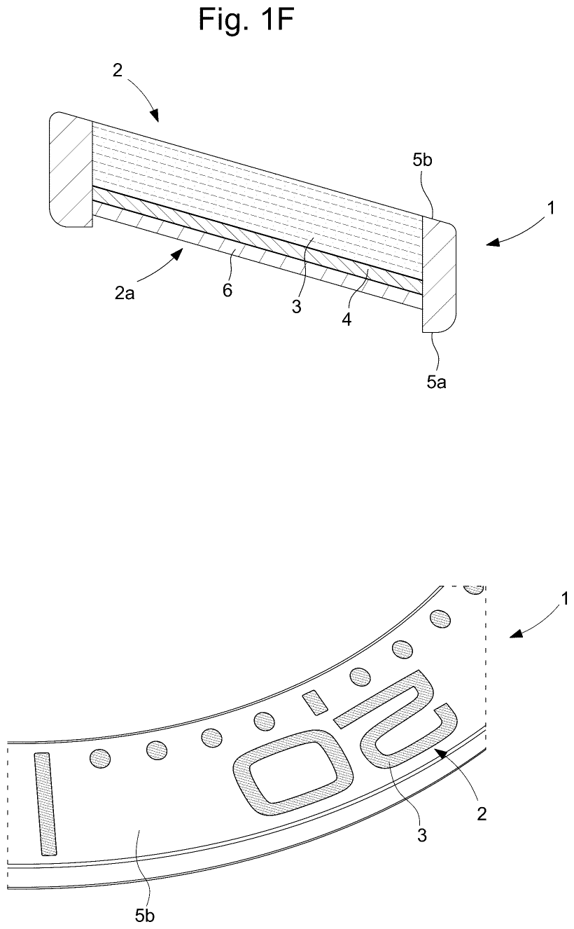

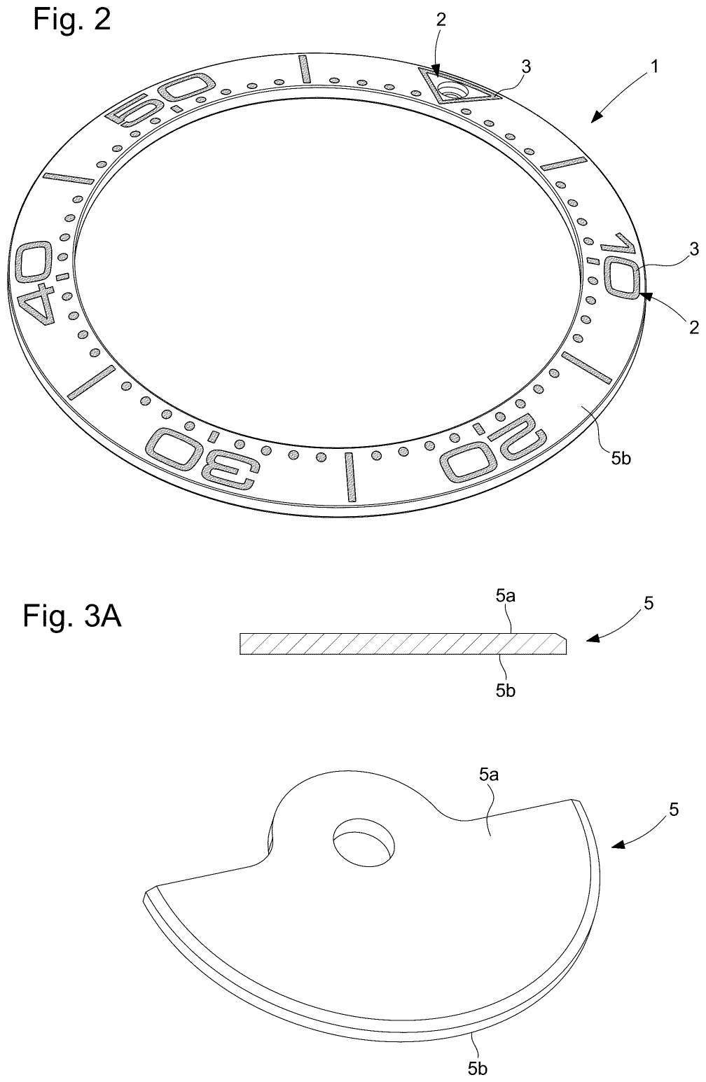

The manufacturing method according to another alternative embodiment is illustrated in FIG. 1A to 1E in 6 steps from a) to e) and in FIG. 2 for a watch bezel. The manufacturing method is essentially the same except that a luminescent material is deposited on the upper face 5a after the enamel layers have been deposited so as to form a backlit plique-à-jour enamel decoration. In this method, the lower face 5b is the face intended to be visible when in use. For this reason, the lower face 5b is shown in the upper position in the figures. It should be noted, however, that in practice, the upper face 5a is positioned in the upper position during the enamel layer deposition step in order to facilitate deposition without the risk of it running.

Steps a, b and c are the same as above. In a fourth step d), once the decoration has been at least partially filled with enamel and fired, a layer of material 4, namely a luminescent material, is deposited on the enamel 3, i.e. still from the upper face 5a of the blank. For example, the luminescent material can be Super-LumiNova®, which is a phosphorescent pigment charged in a lacquer or an adhesive. This material offers a wide range of emission colours, including blue, green, purple, white, yellow, orange and pink, etc. In a fifth step e), a protective layer 6, such as a lacquer, is deposited on the layer of luminescent material 4. A sixth machining step f) is then carried out, preferably by grinding, on the lower face 5b of the blank 5 to reveal the enamel 3, thus obtaining the through-decoration 2 backlit from the inside by the luminescent material 4. A final polishing operation can then be carried out to make the ground surface perfectly shiny and guarantee good transparency of the enamel. The resulting bezel is shown in FIG. 2.

For both of the above alternative embodiments, the engraving and texturing steps can be carried out during the manufacturing method, for example between the enamel layer deposition and firing steps.

Finally, and optionally for both alternative embodiments of the method, one or both faces can be subjected to finishing treatments such as supercalendering, in addition to the laser ablation for engraving and texturing according to the invention.

1. A method for engraving and texturing an item (1) comprising a decoration (2) filled at least partially with an enamel (3), said method comprising a laser ablation step using a femtosecond or picosecond laser on the surface of the enamel (3) and/or within the enamel (3) to produce a structure (7).

2. The engraving and texturing method according to claim 1, wherein it relates to a through-decoration (2) at least partially filled with enamel (3) to form a so-called plique-à-jour enamel.

3. The engraving and texturing method according to claim 1, comprising a step of filling the structure (7) with a material (4).

4. The engraving and texturing method according to claim 1, wherein the wavelength of the laser lies in the near infra-red range, i.e. between 700 and 2500 nm, in the green range, i.e. between 510 and 560 nm, or in the UV range, i.e. between 200 and 400 nm.

5. The engraving and texturing method according to claim 1, wherein the structure (7) within the enamel (3) is obtained by focusing a laser beam (8) within the enamel (3) and by generating a matrix of impacts, whereas the structure (7) at the surface requires focusing the laser beam (8) close to the surface.

6. The engraving and texturing method according to claim 5, wherein the laser beam (8) passes through the enamel (3) in its entirety to produce a structure (7) on a surface opposite the point-of-entry of the laser beam (8).

7. The engraving and texturing method according to claim 4, wherein for the structure (7) within the enamel (3), the wavelength of the laser lies in the near infra-red range and for the structure (7) at the surface, the wavelength of the laser lies in the green range.

8. A method for manufacturing the item (1) comprising the through-decoration (2) filled at least partially with the enamel (3) to form the so-called plique-à-jour enamel, the manufacturing method comprising steps of engraving and texturing according to claim 2, and comprising, before or during said engraving and texturing steps, the steps of:
obtaining a blank (5) defined with an upper face (5a) and a lower face (5b) opposite the upper face (5a);
removing part of the blank (5) from the upper face (5a) to produce a decoration (2a) that does not pass through to the lower face (5b) or, alternatively, in the previous step, obtaining said blank (5) directly with the non-through decoration (2a);
depositing one or more layers of enamel (3) within the non-through decoration (2a) and firing the enamel (3) after each layer has been deposited;
machining, preferably by grinding, the lower face (5b) to reveal the enamel (3) and thus produce the item (1) with the through-decoration (2) filled with enamel (3).

9. The manufacturing method according to claim 8, wherein the lower face (5b) is the face intended to face an observer during use, the manufacturing method comprising a step of depositing a layer of luminescent material on the enamel (3) after the step of firing said enamel (3) and a step of depositing a protective layer (6) on the layer of luminescent material prior to the machining step.

10. The manufacturing method according to claim 8, wherein said blank (5) is made of a material with a melting point greater than or equal to 650° C.

11. The manufacturing method according to claim 8, wherein the deposition of one or more layers of enamel (3) is carried out by liquid spraying, using a brush or by sprinkling a powder.

12. The manufacturing method according to claim 8, wherein the number of layers of enamel (3) deposited is between 2 and 15, preferably between 3 and 10.

13. The manufacturing method according to claim 8, wherein during the step of depositing one or more layers of enamel (3), layers of enamel (3) of different colours are deposited and/or the colour within the same layer is modulated.

14. An item (1) with a decoration (2) made of enamel (3), said decoration (2) comprising, at the surface and/or within the enamel (3), a structure (7).

15. The item (1) according to claim 14, wherein the structure (7) is filled with a material (4), said material (4) being another enamel or a material that is different to enamel (3).

16. The item (1) according to claim 15, comprising a through-decoration (2) made of plique-à-jour enamel with an enamel thickness greater than or equal to 0.5 mm, preferably greater than or equal to 0.8 mm.

17. The item (1) according to claim 16, comprising a layer of luminescent material covering the enamel (3) in the decoration (2).

18. The item (1) according to claim 17, said item (1) being an external timepiece component or component of the movement.

19. The item (1) according to claim 14, said item (1) being made of a ceramic, preferably a zirconium oxide, a sapphire or a cermet.
